(19) United States
(12) Patent Application Publication
(10) Pub. No.: US 2025/0249902 A1
(43) Pub. Date: Aug. 7, 2025

(54) SYSTEMS AND METHODS FOR PERSONALIZED GAP PREFERENCE PREDICTION

(71) Applicant: Toyota Motor Engineering & Manufacturing North America, Inc., Plano, TX (US)

(72) Inventors: Amr Abdelraouf, Redwood City, CA (US); Rohit Gupta, Santa Clara, CA (US); Kyungtae Han, Palo Alto, CA (US); Hazem Abdelkawy, Woluwe Saint Pierre (BE); Jakob Knapp, Brussels (BE)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/431,230

(22) Filed: Feb. 2, 2024

(51) Int. Cl. B60W 30/16; G06V 20/56; G06V 20/58; G06V 20/70

(52) U.S. Cl. CPC B60W 30/16; G06V 20/58; G06V 20/588; G06V 20/70; B60W 2420/403; B60W 2554/4041; B60W 2556/40; B60W 2754/30

(57) ABSTRACT

The disclosed systems and methods for personalized gap preference prediction of an ego vehicle driving on a road include one or more vision sensors operable to capture one or more images of a surrounding scene and one or more processors. The one or more processors are operable to generate a scene graph based on the captured images, generate a scene embedding based on the scene graph, generate vehicle data embedding based on vehicle data of the ego vehicle, concatenate the scene embedding and the vehicle data embedding to generate a time-stamped state, generate a preferred gap related to one of one or more surrounding vehicles by inputting the time-stamped state to a machine learning model, and operate the ego vehicle to keep a gap from the corresponding surrounding vehicle at the preferred gap.

### TECHNICAL FIELD

The present disclosure relates to systems and methods for advanced vehicle driving assistance, more specifically, to systems and methods for advanced vehicle driving assistance for personalized adaptive cruise control.

### BACKGROUND

Traffic congestion occurs when individual drivers prioritize their own interests without considering the collective impact on traffic flow. This self-interested behavior can lead to bottlenecks, longer travel times, and increased fuel consumption. Accordingly, a need exists for a system and method for collaborating among vehicles, particularly those in close proximity, for route planning and traffic management.

### SUMMARY

In one embodiment, a system for personalized gap preference prediction of an ego vehicle driving on a road include one or more vision sensors operable to capture one or more images of a surrounding scene and one or more processors. The one or more processors are operable to generate a scene graph based on the captured images, generate a scene embedding based on the scene graph, generate vehicle data embedding based on vehicle data of the ego vehicle, concatenate the scene embedding and the vehicle data embedding to generate a time-stamped state, generate a preferred gap related to one of one or more surrounding vehicles by inputting the time-stamped state to a machine learning model, and operate the ego vehicle to keep a gap from the corresponding surrounding vehicle at the preferred gap.

In another embodiment, a method for personalized gap preference prediction of an ego vehicle driving on a road includes generating a scene graph based on one or more images of a surrounding scene captured by one or more vision sensors, generating a scene embedding based on the scene graph, generating vehicle data embedding based on vehicle data of the ego vehicle, concatenating the scene embedding and the vehicle data embedding to generate a time-stamped state, generating a preferred gap related to one of one or more surrounding vehicles by inputting the time-stamped state to a machine learning model, and operating the ego vehicle to keep a gap from the corresponding surrounding vehicle at the preferred gap.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for personalized gap preference prediction of the present disclosure, in accordance with one or more embodiments shown and described herewith;

FIG. 2 schematically depicts example components of the system for personalized gap preference prediction of the present disclosure, according to one or more embodiments shown and described herein;

FIG. 3 depicts a block diagram of generating scene embeddings using an example scene encoder of the present disclosure, according to one or more embodiments shown and described herein;

FIG. 4 depicts a block diagram of generating a time-stamped state vector of the present disclosure, according to one or more embodiments shown and described herein;

FIG. 5 depicts a block diagram of generating a preferred gap using an example temporal encoder of the present disclosure, according to one or more embodiments shown and described herein; and

FIG. 6 depicts a flowchart for illustrative steps for generating personalized gap preference of the present disclosure, according to one or more embodiments shown and described herein.

### DETAILED DESCRIPTION

The embodiments disclosed herein include systems and methods for personalized gap preference prediction of an ego vehicle driving on a road. The disclosed systems and methods are different than the one-size-fits-all approach of Adaptive Cruise Control (ACC) by tailoring the gap predictions to an individual users' preferences and providing a more individualized driving experience. The disclosed systems and methods for personalized gap preference prediction for an ego vehicle provide advancement and offer benefits that encompass comfort, risk mitigation, traffic flow improvement, user acceptance, and mitigation of vehicle-related challenges.

The disclosed systems and methods acknowledge that users have varying comfort levels regarding following distances and provide personalized predictions to improve comfort and control during the driving journey. The incorporation of personalized gap predictions also contributes to avoiding undesired conditions that may cause enhanced safety on the road. By considering the users' comfort level while maintaining a safe following distance, the disclosed systems and methods reduce the risk of sudden braking or acceleration, and the likelihood of collisions.

The disclosed systems and methods also offer the advantage of adaptability to different driving conditions. This adaptability improves traffic flow by facilitating smoother acceleration and deceleration based on the individual's driving style. The disclosed systems and methods can dynamically adjust the preferred gap to align with factors such as weather conditions, road type, and traffic density, contributing to more efficient traffic management.

The disclosed systems and methods can extend to scenarios involving overtaking and lane changes. With the adjustment and alignment of the vehicle operation and performance with the users' preferred following distance, the vehicles may change lanes or pass other vehicles with a seamless and well-coordinated driving experience.

Various embodiments of the methods and systems for sharing detected changes of roads using blockchains are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

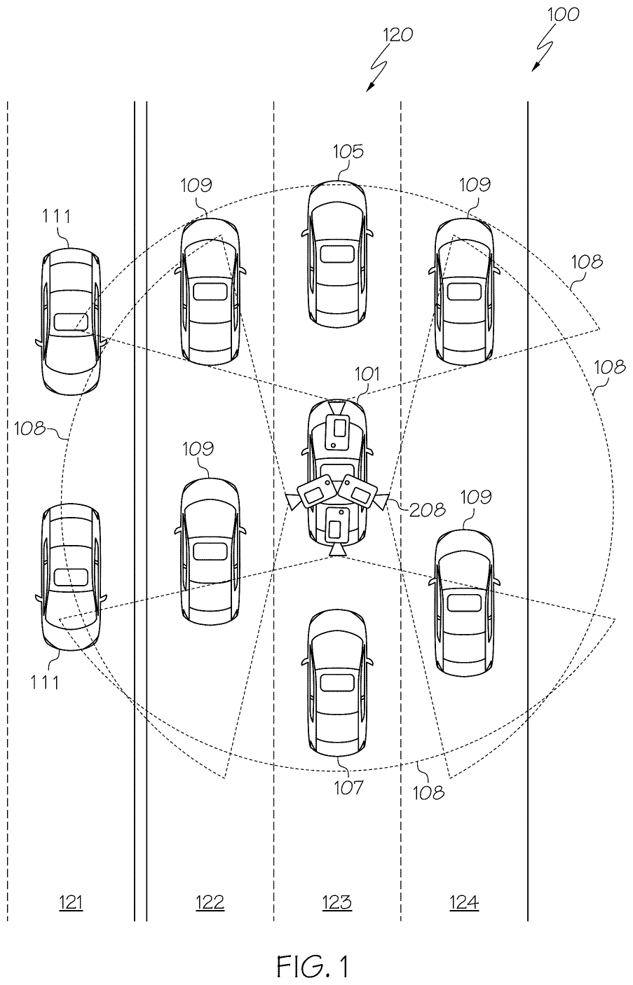

Turing to figures, by referring to FIGS. 1 through 6, in embodiments, the scene graph 341 is generated based on one or more scene images 301 of a surrounding scene of an ego vehicle 101 captured by one or more visions sensors 208 of the ego vehicle 101. The one or more scene images 301 are captured at time t. The scene graph 341 may be used to generate a scene embedding 381, which is used to concatenate with vehicle data embedding 421 to generate a state 441 at time t. The one or more scene images 310 may be obtained periodically, for example, every 0.1 second. The generated sequence states 441 in a span of T before t may be used to generate a preferred gap between the ego vehicle 101 to surrounding vehicles 105, 107, and 109.

FIG. 1 schematically depicts an example personalized gap preference prediction system 100. The personalized gap preference prediction system 100 includes a plurality of vehicles 101, 105, 107, 109, and 111. Each of the vehicles 101, 105, 107, 109, and 111 may be an automobile or any other passenger or non-passenger vehicle such as, for example, a terrestrial, aquatic, and/or airborne vehicle. Each of the vehicles 101, 105, 107, 109, and 111 may be an autonomous vehicle that navigates its environment with limited human input or without human input. Each of the vehicles 101, 105, 107, 109, and 111 may drive on a road and perform vision-based lane centering, e.g., using a sensor. Each of the vehicles 101, 105, 107, 109, and 111 may include actuators for driving the vehicle, such as a motor, an engine, or any other powertrain. The vehicles 101, 105, 107, 109, and 111 may move on various surfaces, such as, without limitations, roads, highways, streets, expressways, bridges, tunnels, parking lots, garages, off-road trails, railroads, or any surfaces where the vehicles may operate. As illustrated in FIG. 1, the vehicles 101, 105, 107, 109, and 111 may move on a non-limiting example road 120 including multiple lanes, such as two or three lanes, in both driving directions. For example, the road 120 may include a left lane 122, a middle lane 123, and a right lane 124 to the north direction, and at least one lane 121 on the south direction. The vehicles 101 and 105, 107, and 109 in the north direction of the road 120 may move to the north direction in the three lanes 122, 123, and 124, and the vehicles 111 may move to the south direction in the lane 121. Each vehicle 101, 105, 107, 109, and 111 may move within a lane or change lanes to another lane moving in the same direction.

In embodiments, the vehicle 101 is an ego vehicle 101, and the vehicles 105, 107, and 109 are vehicles surrounding the ego vehicle 101. The surrounding vehicles 105, 107, and 109) may move on the road 120 in the same direction as the ego vehicle 101. The vehicle 105 is a lead vehicle 105 to the ego vehicle 101, the vehicle 107 is a rear vehicle 107 to the ego vehicle 101 and the vehicles 109 are adjacent-lane vehicles 109 to the ego vehicle 101. The lead vehicle 105 and the rear vehicle 107 may be the surroundings vehicle moving in the same lane or the same moving track related to the ego vehicle 101. The adjacent-lane vehicles 109 may be the surrounding vehicles moving in a different lane or track next to the lane or track that the ego vehicle 101 is moving in. The proximity between the ego vehicle 101 and the surrounding vehicles 105, 107, and 109 may refer to the gap between the ego vehicle 101 and the surrounding vehicles 105, 107, and 109. The gap may accordingly include a front gap referring to the gap between the lead vehicle 105 and the ego vehicle 101, a rear gap referring to the gap between the rear vehicle 107 and the ego vehicle 101, and one or more side gaps between the adjacent-lane vehicles 109 and the ego vehicle 101.

The ego vehicle 101 may include one or more vision sensors 208 operable to capture one or more scene images of a surrounding scene. The one or more vision sensors 208 may include one or more front-view vision sensors, one or more rearview vision sensors, and/or one or more side-view vision sensors. The one or more vision sensors 208 may capture scenes surrounding the ego vehicle 101. For example, the front vision sensors may capture scenes in front of the ego vehicle 101, the rear vision sensors may capture scenes behind the ego vehicle 101, and the side-view vision sensors may capture scenes one the left side and/or right side of the ego vehicle 101. Each vision sensor 208 may capture a scene defined by a field of view (FOV) 108. As illustrated in FIG. 1, the non-limiting FOV 108 includes the adjacent area of the ego vehicle 101 that covers the lead vehicle 105, rear vehicle 107, the adjacent-lane vehicles 109, other surrounding vehicles, and adjacent areas of the road 120. It should be appreciated that the FOV 108 of the vision sensor 208 may cover greater areas dependent on the vision sensor 208 used by the ego vehicle 101.

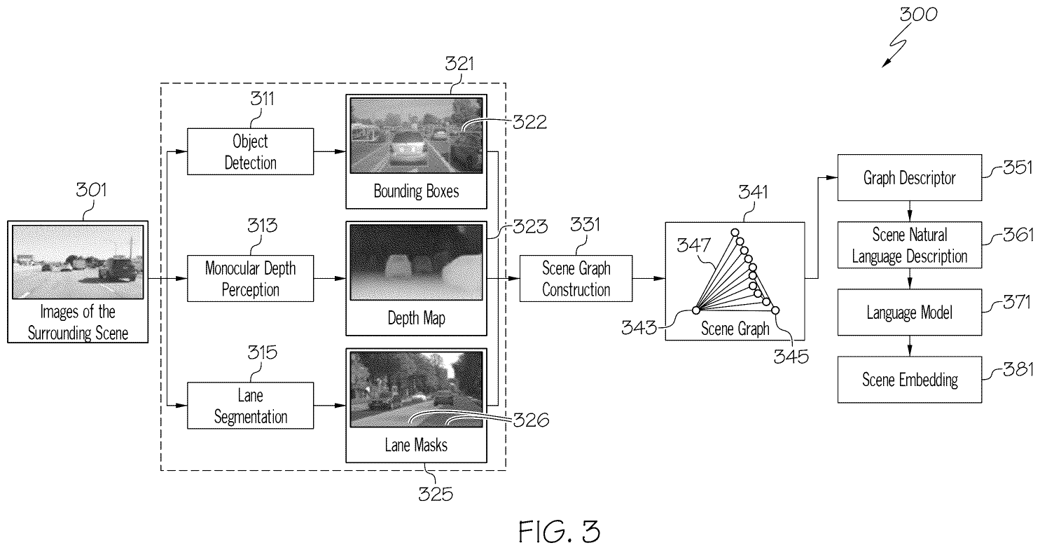

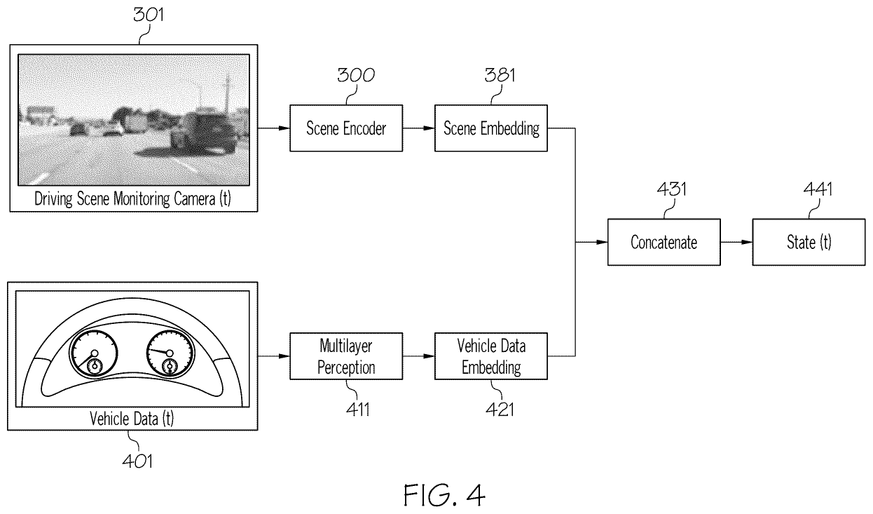

The ego vehicle 101 may include other sensors 212 to collect vehicle data 401 (as in FIG. 4) for generating vehicle data embeddings 421 (as in FIG. 4). The ego vehicle 101 may include one or more vehicle modules, including, without limitations, scene embedding module 222 and a preferred gap module 232. The one or more modules may be utilized by ego vehicle 101 in predicting one or more personalized gap preferences for the users of the ego vehicle 101 and operating the ego vehicle 101 keeping a gap from the surrounding vehicles 105, 107, and 109 at corresponding preferred gaps. Each of the vehicle modules may include one or more machine learning algorithms. The vehicle modules and the server modules may be trained and provided machine learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in a field of machine learning, for example, is a class of deep, feed-forward ANNs applied for audio analysis of the recordings. CNNs may be shift or space invariant and utilize shared-weight architecture and translation. Further, each of the various modules may include a generative artificial intelligence algorithms. The generative artificial intelligence algorithm may include a general adversarial network (GAN) that has two networks, a generator model and a discriminator model. The generative artificial intelligence algorithm may also be based on variation autoencoder (VAE) or transformer-based models. The one or more modules may include one or more language model, such as Natural Language Processing (NLP) model. The NLP may include an encoder. The Encoder of the NLP model may tokenize input to the encoder, such as a scene natural language description 361 (as in FIG. 3), and output embeddings, such as the scene embedding 381 (as in FIG. 3) that may be one or more vectors in a continuous vector space. The NLP model may have a layered architecture with self-attention mechanisms for capturing contextual dependencies.

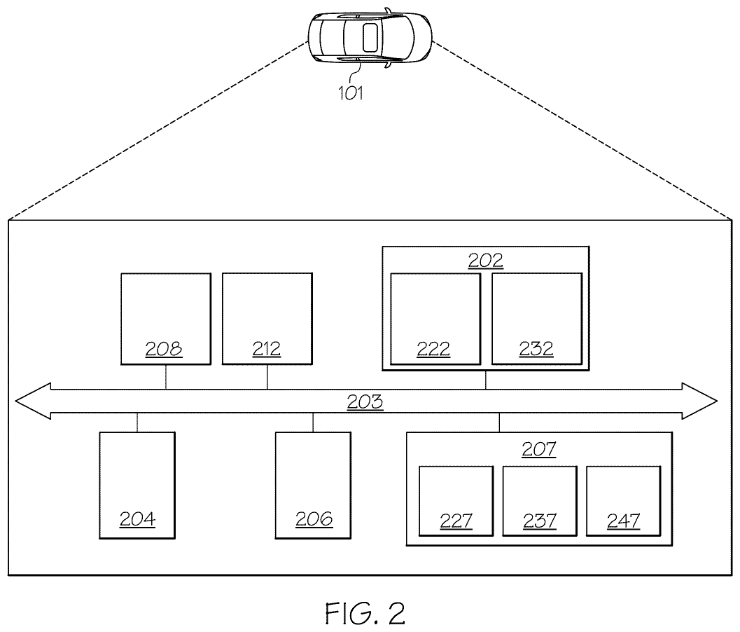

The one or more vehicle modules may be pre-trained using training data of the personalized gap preference prediction, including ground-truth examples and scenarios where multiple entities (e.g. one or more ego vehicles 101 and a plurality of surrounding vehicles 105, 107, 109 move on roads or other surfaces while considering the positions of one or more centered entities and the other entities, operation conditions of the entities (for example, the speed, the direction, the acceleration, the reactions to other entities of the entities), gaps between the entities, and factors (for example, without limitation, environments, weather, road conditions, etc.). The pre-training may include labeling the entities and desirable personalized gap preference results in the examples and scenarios and using one or more machine learning models to learn to predict the desirable and undesirable personalized gap preference results based on the training data. The pre-training may further include fine tuning, evaluation, and testing steps. The one or more vehicle modules may be continuously trained using the real-world collected data to adapt to changing conditions and factors and improve the performance over time. The one or more vehicle modules may be continuously trained during the operation of the ego vehicle 101, using the collected data and generated data, such as historical scene embedding data 227, historical vehicle embedding data 237, and/or historical preferred gap data 247 (as in FIG. 2).

FIG. 2 schematically depicts example components of the ego vehicle 101 in the personalized gap preference prediction system 100. While FIG. 2 depicts one ego vehicle 101, more than two ego vehicles 101 may be included in the personalized gap preference prediction system 100. The ego vehicle 101 may include one or more processors 204. Each of the one or more processors 204 may be any device capable of executing machine-readable and executable instructions. The instructions may be in the form of a machine-readable instruction set stored in data storage component 207 and/or the memory component 202. Accordingly, each of the one or more processors 204 may be a controller, an integrated circuit, a microchip, a computer, or any other computing device. The one or more processors 204 are coupled to a communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 203 may be formed from any medium that is capable of transmitting a signal such as, for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square-wave, vibration, and the like, capable of traveling through a medium.

The ego vehicle 101 may include one or more memory components 202 coupled to the communication path 203. The one or more memory components 202 may comprise RAM, ROM, flash memories, hard drives, or any device capable of storing machine-readable and executable instructions such that the machine-readable and executable instructions can be accessed by the one or more processors 204. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 204 along with the one or more memory components 202 may operate as a controller for the ego vehicle 101.

The one or more memory components 202 may include a scene embedding module 222 and a preferred gap module 232. Each of the modules 222 and 232 may include, but are not limited to, routines, subroutines, programs, objects, components, data structures, and the like for performing specific tasks or executing specific data types as will be described below. The data storage component 207 stores historical scene embedding data 227, historical vehicle embedding data 237, historical preferred gap data 247, data generated by the sensors, and data of operating the ego vehicle 101 and the vision sensors 208. The modules 222 and 232 may also be stored in the data storage component 207 during operating or after operation.

Referring still to FIG. 2, the ego vehicle 101 may include one or more vision sensors 208. The one or more vision sensors 208 may include a selection of, without limitations, a proximity sensor, a camera, a light detection and ranging (LIDAR) sensor, a thermal image sensor, an infrared sensor, an ultrasonic sensor, and/or a combination thereof. The camera may be, without limitation, a red, green, and blue (RGB) camera, a depth camera, an infrared camera, a wide-angle camera, or a stereoscopic camera. The one or more vision sensors 208 may be any device having an array of sensing devices capable of detecting radiation in an ultraviolet wavelength band, a visible light wavelength band, or an infrared wavelength band. The one or more vision sensors 208 may have any resolution. In some embodiments, one or more optical components, such as a mirror, fish-eye lens, or any other type of lens may be optically coupled to the one or more vision sensors 208. In embodiments described herein, the one or more vision sensors 208 may provide image data to the one or more processors 204 or another component communicatively coupled to the communication path 203. In some embodiments, the one or more vision sensors 208 may also provide navigation support. That is, data captured by the one or more vision sensors 208 may be used to autonomously or semi-autonomously navigate a vehicle.

In some embodiments, the one or more vision sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain rough depth and speed information for the view of the ego vehicle 101.

The ego vehicle 101 may include one or more other sensors 212. Each of the one or more other sensors 212 is coupled to the communication path 203 and communicatively coupled to the one or more processors 204. The one or more other sensors 212 may include one or more motion sensors for detecting and measuring motion and changes in the motion of a vehicle. The motion sensors may include inertial measurement units. Each of the one or more motion sensors may include one or more accelerometers and one or more gyroscopes. Each of the one or more motion sensors transforms the sensed physical movement of the vehicle into a signal indicative of an orientation, a rotation, a velocity, or an acceleration of the vehicle.

The ego vehicle 101 may include network interface hardware 206 for communicatively coupling the ego vehicle 101 to the surrounding vehicles 105, 107, and 109 and/or a server. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The network interface hardware 206 of the ego vehicle 101 may transmit its data to the surrounding vehicles 105, 107, and 109 or the server. For example, the network interface hardware 206 of the ego vehicle 101 may transmit vehicle data, location data, updated local model data, and the like to the surrounding vehicles 105, 107, and 109 or the server.

FIG. 3 depicts an example block diagram of generating a scene embedding 381 using the scene encoder 300 of the present disclosure. The personalized gap preference prediction system 100 may capture, using the one or more vision sensors 208, one or more scene images 301, including the images and/or video frames of the surrounding scene. The scene images 301 may reflect the one or more of FOVs 108 of the corresponding vision sensors 208, such as the front FOV, the rear FOV, and/or the side FOVs.

The scene embedding module 222 in FIG. 2 may include an object detection module 311, a monocular depth perception module 313, and/or a lane segmentation module 315. The object detection module 311, the monocular depth perception module 313, and/or the lane segmentation module 315 may be pre-trained on a dataset containing pairs of images and corresponding ground truth depth maps obtained from vision sensors 208 like LiDARs or stereo cameras.

The object detection module 311 may detect and classify objects, such as the surrounding vehicles 105, 107, and 109, pedestrians, cyclists, motorcycles, moving objects, and/or obstacles through object detection, in the scene images 301. The scene embedding module 222 may implant one or more bounding boxes 322 to the detected objects in the scene images 301 to generate one or more bounding box images 321. The object detection module 311 may include a neural network (e.g., a YOLOv5) to generate a set of object detections with objects, where each object is described with a bounding box 322, a class, and a detection confidence score between 0 and 1. The scene embedding module 222 may implant one or more bounding boxes 322 to the detected objects in the scene images 301 to generate one or more bounding box images 321.

The monocular depth perception module 313 may estimate the three-dimensional structure of the surrounding scene, and coordinates of the objects detected using the object detection module 311, such as the surrounding vehicles 105, 107, and 109, pedestrians, cyclists, motorcycles, moving objects, and/or obstacles through object detection in the scene images 301. The monocular depth perception module 313 may estimate the proximity of the objects within the scene images 301 and extract hierarchical features from the scene images 301 to generate corresponding depth maps 323. The coordinate of a detected object may be estimated by calculating the mean value of the depth map 323 contained inside the bounding box 322 of the corresponding detected object in the image space. In some embodiments, the monocular depth perception module 313 may include an encoder and a decoder, with multiple layers of neural network.

The lane segmentation module 315 may identify and segment lanes (e.g., the lanes 121, 122, 123, and 124 in FIG. 1) in the scene image 301. The scene embedding module 222 may recognize the pixels corresponding to the lanes and create one or more binary lane masks 326 that highlight the lane boundaries. The lane segmentation module 315 may have a convolutional neural network (CNN) architecture with an encoder, a decoder, and a backbone (e.g., UNetFormer). The lane segmentation module 315 may extract the pixel of the scene images 301 and assign each of the pixels a corresponding label to corresponding lane images 325, indicating whether the pixel may belong to a certain lane or not. Based on the corresponding lane mask 326, the scene embedding module 222 may add a lane index to each detected objects in the bounding box images 321. For example, the personalized gap preference prediction system 100 may know whether a surrounding vehicles 105, 107, or 109 is in the same lane or a different lane as the ego vehicle 101, or whether the different lane is adjacent to the lane that the ego vehicle 101 is moving in.

The scene embedding module 222 may conduct a scene graph construction 331 by combining the bounding box images 321, the depth map 323, and/or the lane images 325 to generate a scene graph 341. In embodiments, the scene graph 341 may be constructed by representing each of the detected objects in the bounding box images 321 and the ego vehicle 101 as vertices in a weighted undirected graph. As illustrated in FIG. 3, the scene graph 341 may include an ego vehicle node 343 representing the ego vehicle 101, one or more surrounding vehicle nodes 345 representing the surrounding vehicles 105, 107, and 109, and edges 347 between the ego vehicle 101 and each of the surrounding vehicles 105, 107, and 109 representing the relative proximity between the ego vehicle 101 and the corresponding surrounding vehicles 105, 107, or 109 in terms of both direction and scalar distance. A weight of each edge 347 may be a function of Euclidean distance between the ego vehicle 101 and the corresponding surrounding vehicle 105, 107, or 109.

The scene embedding module 222 may include a Graph Descriptor 351 to convert the scene graph 341 to a standard graph representation that is a scene natural language description 361. In embodiments, the scene natural language description 361 may identify and extract pertinent information regarding the spatial arrangement of the nodes 343 and 345 in the scene graph 341, by assessing distances, relative positions, or other spatial characteristics that capture the relationships between the ego vehicle node 343 and the surrounding vehicle nodes 345. The assessing may further consider the weighted edge 347 based on the Euclidean distance between the ego vehicle node 343 and the surrounding vehicle node 345. With the proximity analysis, the Graph Descriptor 351 may translate the spatial information into the scene natural language description 361, which may be a human-readable representation of the spatial relationships within the scene graph 341.

The scene embedding module 222 may include a language model 371 (e.g., a Natural Language Processing (NLP) model) to convert the scene natural language description 361 to one or more scene embeddings 381. The scene embeddings 381 may be fed to mathematical functions for the computation of a similarity score between different scenes in the embedding space.

Referring to FIG. 4, a block diagram of generating an example time-stamped state vector is depicted. The scene embedding module 222 in FIG. 2 may feed the scene images 301 captured at a timestamp (t) by one or more vision sensors 208, such as the front-view scene image captured by the front view vision sensor, the rearview scene image captured by the rearview vision sensor, the side-view scene images captured by the side-view vision sensor to the scene encoder 300 to generate the scene embeddings 381, as described above. The personalized gap preference prediction system 100 may collect vehicle data, such as, without limitations, the speed, moving direction, acceleration, and other vehicle operation data, at the time stamp (t) using the one or more other sensors 212. The personalized gap preference prediction system 100 may include a Multi-Layer Perceptron (MLP) neural network 411 and feed the vehicle data to the MLP 411 to generate a vehicle data embedding 421. The MLP 411 may be a misnomer for a feedforward artificial neural network, consisting of connected neurons with a nonlinear activation function, organized in three or more layers. The personalized gap preference prediction system 100 may further concatenate 431 the scene embedding 381 and the vehicle data embedding 421 at the time stamp (t) to generate a vector state at the timestamp (t). The merge of the scene embedding 381 and the vehicle data embedding 421 at the timestamp (t) results in a vector state that encapsulates both the spatial understanding derived from the surrounding scene of the ego vehicle 101 and the dynamic characteristics of the ego vehicle 101 revealed by the vehicle data. The vector state at a specific timestamp (t) thus represents a snapshot of the perception of the environment of the ego vehicle 101 and the surrounding vehicles 105, 107, and 109 at that moment.

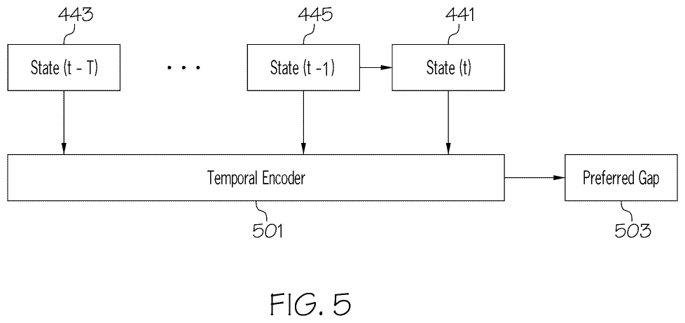

Referring to FIG. 5, a block diagram of generating a preferred gap using an example temporal encoder 501 is depicted. The preferred gap module 232 in FIG. 2 may include a temporal encoder 501 to encode one or more sequence vector states before the current vector state at timestamp (t), such from timestamp (t-T) 443 to timestamp (t-1) 445, where T is the span of the sequence timestamps. The preferred gap module 232 may feed the sequence vector states as inputs to the temporal encoder 501 to capture and interpret the evolving surrounding scenes, such as traffic context, over time. The temporal encoder 501 may synthesize spatiotemporal nuances of the moving situation of the ego vehicle 101 for preferred gap prediction. The temporal encoder 501 may output one or more preferred gaps 503. The preferred gaps 503 may include a following gap to the lead vehicle 105, a rear gap to the rear vehicle 107, and/or one or more side gaps from the adjacent-lane vehicles 109. Each preferred gap may represent a desirable proximity for the ego vehicle 101 from a corresponding surrounding vehicle 105, 107, or 109, considering the current and past surrounding scenes and traffic conditions. The preferred gap module 232 may be pre-trained and continuously trained end-to-end using a supervised learning approach. The training may be fueled by a dataset comprising diverse real-world driving scenarios, with each instance annotated with the preferred gap identified by experienced human drivers.

In some embodiments, the personalized gap preference prediction system 100 can personalize gaps according to each user's preferences by fine tuning the one or more modules, such as the model weights using the user driving data. For instance, when the user operates the ego vehicle 101 without the assistance of the personalized gap preference prediction system 100, the personalized gap preference prediction system 100 may collect and feed the scene image 301 regarding the surrounding vehicles 105, 107, and 109 and operation vehicle data to the one or more modules to generate predicted preferred gap 503 and compare with the corresponding gap maintained by the user to further tuning the described models in the one or more modules

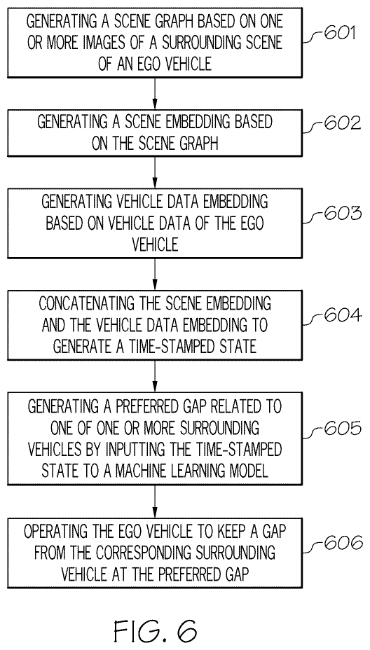

FIG. 6 depicts illustrative example method for generating personalized gap preference. At block 601, the present method generates a scene graph based on one or more scene images of a surrounding scene captured by one or more vision sensors. By referring to FIGS. 1 through 3, in embodiments, the scene graph 341 is generated based on one or more scene images 301 of a surrounding scene of an ego vehicle 101 captured by one or more visions sensors 208 of the ego vehicle 101. The one or more scene images 301 are captured at time t. The one or more scene images 310 may be obtained periodically, for example, every 0.1 second.

In some embodiments, the present method may further include extracting visual information of the one or more surrounding vehicles 105, 107, and 109 and the road 120, and generating the scene graph 341 based on the extracted visual information. The visual information may include the detected one or more surrounding vehicles 105, 107, and 109, the depth map 323, and the lane masks 326. While the vehicles 111 are detected by one of vision sensors 208, the vehicles 111 are excluded from the surrounding vehicles of the ego vehicle 101 based on information about the lane masks 326 because the vehicles 111 are driving in the opposite direction compared to the ego vehicle 101. The present method may include detecting the one or more surrounding vehicles 105, 107, and 109 from the scene images 301 using the object detection module 311, generating a depth map 323 of the one or more surrounding vehicles 105, 107, and 109 using the monocular depth perception module 313, and generating lane masks 326 using the lane segmentation module 315. The surrounding vehicles 105, 107, and 109 may be a lead vehicle, a rear vehicle, one or more adjacent-lane vehicles, or a combination thereof. The one or more vision sensors 208 may be one or more front-view vision sensors, one or more rearview vision sensors, one or more side-view vision sensors, or a combination thereof.

In some embodiments, the scene graph 341 may include the ego vehicle node 343 corresponding to the ego vehicle 101, one or more surrounding vehicle nodes 345 corresponding to the surrounding vehicles 105, 107, and 109, and the edges 347 between the ego vehicle node 343 and the one or more surrounding vehicle nodes 345. The edges 347 may be vectors based on relative directions and distances between the ego vehicle 101 and the one or more surrounding vehicles 105, 107, and 109. A weight of each edge 347 may be a function of Euclidean distance between the ego vehicle 101 and the corresponding vehicle 105, 107, or 109.

Referring back to FIG. 6, at block 602, the present method generates a scene embedding based on the scene graph. By referring to FIG. 3, in embodiment, the scene embedding 381 is generated based on the scene graph 341. In some embodiments, the present method may further convert the scene graph 341 to a standard graph representation, generating a description of the scene (e.g., the scene natural language description 361 in FIG. 3) based on the standard graph representation, and feeding the description to the NLP model 371 to generate the scene embedding 381. The scene natural language description 361 may include one or more sentences in natural language.

Referring back to FIG. 6, at block 603, the present method generates vehicle data embedding based on vehicle data of the ego vehicle. By referring to FIG. 4, the present method generates a vehicle data embedding 421 based on vehicle data 401 of the ego vehicle. The present method feed the vehicle data to the MLP 411 to generate the vehicle data embedding 421.

Referring back to FIG. 6, at block 604, the present method concatenates the scene embedding and the vehicle data embedding to generate a time-stamped state. By referring to FIG. 4, the present method concatenates the scene embedding 381 and the vehicle data embedding 421 to generate a time-stamped state 441.

Referring back to FIG. 6, at block 605, the present method generates a preferred gap related to one of one or more surrounding vehicles by inputting the time-stamped state to a machine learning model. By referring to FIG. 5, the present method generates the preferred gap 503 related to one of one or more surrounding vehicles by inputting the time-stamped state 441 to a machine learning model such as the temporal encoder 501. The present method may further include obtaining multiple time-stamped states (e.g., the states 443, 445, and 441 as in FIG. 5) in sequential time stamps (e.g., time stamps from (t-T) to t) based on scene images 301 of the surrounding scene captured at different times and driving data obtained at the different times, and inputting the multiple time-stamped states in sequential time stamps to the temporal encoder 501 to generate the preferred gap 503.

Referring back to FIG. 6, at block 606, the present method operates the ego vehicle to keep a gap from the corresponding surrounding vehicle at the preferred gap. By referring to FIGS. 1 and 5, the ego vehicle 101 keeps a gap between the ego vehicle 101 and a surrounding vehicle such as the lead vehicle 105 at the preferred gap 503.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for personalized gap preference prediction of an ego vehicle driving on a road comprising:
one or more vision sensors operable to capture one or more images of a surrounding scene; and
one or more processors operable to:
generate a scene graph based on the captured images;
generate a scene embedding based on the scene graph;
generate vehicle data embedding based on vehicle data of the ego vehicle;
concatenate the scene embedding and the vehicle data embedding to generate a time-stamped state;
generate a preferred gap related to one of one or more surrounding vehicles by inputting the time-stamped state to a machine learning model; and
operate the ego vehicle to keep a gap from the corresponding surrounding vehicle at the preferred gap.

2. The system of claim 1, wherein the one or more processors are operable to:
extract visual information of the one or more surrounding vehicles and the road; and
generate the scene graph based on the extracted visual information.

3. The system of claim 2, wherein one or more processors are operable to:
detect the one or more surrounding vehicles from the captured images using an object detection module;
generate a depth map of the one or more surrounding vehicles using a monocular depth perception module; and
generate lane masks using a lane segmentation module, and
the visual information comprises the detected one or more surrounding vehicles, the depth map, and the lane masks.

4. The system of claim 1, wherein the scene graph comprises:
an ego vehicle node corresponding to the ego vehicle;
one or more surrounding vehicle nodes corresponding to the surrounding vehicles; and
edges between the ego vehicle node and the one or more surrounding vehicle nodes.

5. The system of claim 4, wherein the edges are vectors based on relative directions and distances between the ego vehicle and the one or more surrounding vehicles.

6. The system of claim 4, wherein a weight of each edge is a function of Euclidean distance between the ego vehicle and the corresponding vehicle.

7. The system of claim 1, wherein the one or more processors are further operable to:
convert the scene graph to a standard graph representation;
generate a description of the scene based on the standard graph representation, wherein the description comprises one or more sentences in natural language; and
feed the description to a natural language processing model to generate the scene embedding.

8. The system of claim 1, wherein the machine learning model is a temporal encoder.

9. The system of claim 8, wherein the one or more processors are further operable to:
obtain multiple time-stamped states in sequential time stamps based on images of the surrounding scene captured at different times and driving data obtained at the different times; and
input the multiple time-stamped states in sequential time stamps to the temporal encoder to generate the preferred gap.

10. The system of claim 1, wherein the surrounding vehicles are a lead vehicle, a rear vehicle, one or more adjacent-lane vehicles, or a combination thereof.

11. The system of claim 1, wherein the one or more vision sensors comprise one or more front-view vision sensors, one or more rearview vision sensors, one or more side-view vision sensors, or a combination thereof.

12. A method for personalized gap preference prediction of an ego vehicle driving on a road comprising:
generating a scene graph based on one or more images of a surrounding scene captured by one or more vision sensors;
generating a scene embedding based on the scene graph;
generating vehicle data embedding based on vehicle data of the ego vehicle;
concatenating the scene embedding and the vehicle data embedding to generate a time-stamped state;
generating a preferred gap related to one of one or more surrounding vehicles by inputting the time-stamped state to a machine learning model; and
operating the ego vehicle to keep a gap from the corresponding surrounding vehicle at the preferred gap.

13. The method of claim 12, wherein the method further comprises:
extracting visual information of the one or more surrounding vehicles and the road; and
generating the scene graph based on the extracted visual information.

14. The method of claim 13, wherein the method further comprises:
detect the one or more surrounding vehicles from the captured images using an object detection module;
generate a depth map of the one or more surrounding vehicles using a monocular depth perception module; and
generate lane masks using a lane segmentation module, and
the visual information comprises the detected one or more surrounding vehicles, the depth map, and the lane masks.

15. The method of claim 12, wherein the scene graph comprises:
an ego vehicle node corresponding to the ego vehicle;
one or more surrounding vehicle nodes corresponding to the surrounding vehicles; and
edges between the ego vehicle node and the one or more surrounding vehicle nodes.

16. The method of claim 15, wherein:
the edges are vectors based on relative directions and distances between the ego vehicle and the one or more surrounding vehicles; and
a weight of each edge is a function of Euclidean distance between the ego vehicle and the corresponding vehicle.

17. The method of claim 12, wherein the method further comprises:
converting the scene graph to a standard graph representation;
generating a description of the scene based on the standard graph representation, wherein the description comprises one or more sentences in natural language; and
feeding the description to a natural language processing model to generate the scene embedding.

18. The method of claim 12, wherein the machine learning model is a temporal encoder and the method further comprises:
obtaining multiple time-stamped states in sequential time stamps based on images of the surrounding scene captured at different times and driving data obtained at the different times; and
inputting the multiple time-stamped states in sequential time stamps to the temporal encoder to generate the preferred gap.

19. The method of claim 12, wherein the surrounding vehicles are a lead vehicle, a rear vehicle, one or more adjacent-lane vehicles, or a combination thereof.

20. The method of claim 12, wherein the one or more vision sensors comprise one or more front-view vision sensors, one or more rearview vision sensors, one or more side-view vision sensors, or a combination thereof.
